(19) United States
(12) Patent Application Publication
(10) Pub. No.: US 2004/0031868 A1
(43) Pub. Date: Feb. 19, 2004

(54) Magnetic tape cartridge

(75) Inventor: Hiroyuki Tahara, Kanagawa (JP)

Correspondence Address: Sughrue Mion PLLC, 2100 Pennsylvania Avenue, NW, Washington, DC, 20037-3213, US

(73) Assignee: FUJI PHOTO FILM CO., LTD.

(21) Appl. No.: 10/461,876

(22) Filed: Jun. 16, 2003

(30) Foreign Application Priority Data
Jun. 14, 2002 (JP) 2002-174257

(51) Int. Cl. G11B 23/087; G11B 23/107

(52) U.S. Cl. 242/346.2; 242/348

(57) ABSTRACT

A magnetic tape cartridge of the present invention can restrain uneven winding of a magnetic tape. The magnetic tape can be restrained, and the magnetic tape cartridge of this invention comprises a cartridge case, a reel, housed inside this cartridge case and around which a magnetic tape is wound, and a tape guide, disposed alongside the abovementioned reel guiding the abovementioned magnetic tape so as to separate magnetic tape once from the magnetic tape wound around reel, and guiding the abovementioned separated magnetic tape so that it contacts again the outer peripheral surface of the wound magnetic tape, wherein the magnetic tape that contacts the outer peripheral surface of the wound magnetic tape is restrained in vibration in the tape width direction.

### BACKGROUND OF THE INVENTION

1. Field of the Invention

This invention relates to a magnetic tape cartridge in which a magnetic tape is wound.

2. Description of the Prior Arts

Magnetic tape cartridges, with which a magnetic tape is wound around a reel or reels and housed inside a cartridge case, are widely known. In general, such a magnetic tape cartridge has one or two of the abovementioned reels. With a magnetic tape cartridge having just one reel, when data are to be recorded or reproduced by a magnetic tape drive, a tape loading mechanism of the magnetic tape drive draws out and conveys the tape to a magnetic head of the magnetic tape drive, and when the recording or reproduction is ended, the magnetic tape is wound around the reel again and housed inside the cartridge case. In the case of a magnetic tape cartridge with two reels, magnetic tape that has been drawn out from one of the reels has data recorded or reproduced by a magnetic head of a magnetic tape drive and is thereafter wound around the other reel.

When such a magnetic tape cartridge is used, due to various reasons, the ends in the width direction of a magnetic tape become unaligned, that is, so-called uneven winding occurs. For example, when a magnetic tape is introduced into a cartridge case from a magnetic tape drive, since the magnetic tape vibrates in the width direction due to vibration of the magnetic tape drive, etc., the ends of the magnetic tape may become unaligned in accordance to this vibration, thus giving rise to uneven winding.

Also, when a magnetic tape is wound around a reel, air that accompanies the tape is caught between the outer periphery of the magnetic tape that is already wound and the magnetic tape that is being newly wound. When more magnetic tape is wound anew around the outer periphery of the wound magnetic tape, pressure from the outer side is applied to the air that has caught. As more magnetic tape is wound around the outer periphery and the abovementioned air reaches a certain pressure, this air becomes released from between the magnetic tape. In this process, the magnetic tape adjacent to the air layer moves irregularly in the width direction, and uneven winding of magnetic tape can thus occur due to such a phenomenon. Uneven winding tends to occur especially when the magnetic tape winding speed is high since air is caught more readily.

Such uneven winding not only damages the aesthetic appearance of a magnetic tape cartridge as a product but is also a problem in terms of practical use. For example, when in a case where just a single layer of magnetic tape protrudes greatly, the magnetic tape cartridge is dropped inadvertently, the protruding magnetic tape may hit a reel flange or the inner surface of the cartridge case and the tape edge may thus become bent.

Uneven winding can also cause vibration of the magnetic tape in the width direction when the magnetic tape is drawn out from the magnetic tape cartridge. Given the high density of recording onto magnetic tape that is being realized recently, such vibration can cause tracking error at a magnetic head and impede accurate recording and reproduction of data. This invention was made under such a background and an object thereof is to provide a magnetic tape cartridge, with which uneven winding of magnetic tape can be restrained.

### SUMMARY OF THE INVENTION

In order to achieve the above object, this invention provides a magnetic tape cartridge comprising: a cartridge case; a reel, housed inside this cartridge case and around which a magnetic tape is wound; and a tape guide, disposed alongside the abovementioned reel, guiding the abovementioned magnetic tape so as to separate it once from the magnetic tape wound around the reel, and guiding the abovementioned separated magnetic tape so that it contacts again the outer peripheral surface of the abovementioned wound magnetic tape.

With this magnetic tape cartridge, the magnetic tape, in the process of being wound around a reel, contacts once the outer periphery of the magnetic tape that has been wound already and is thereafter guided in the running direction by the tape guide disposed in the cartridge case and wound around the outer periphery of the wound magnetic tape. The outer periphery of the wound magnetic tape is thus constantly put in contact with running magnetic tape, and irregular movement in the width direction of the tape that occurs when the air sandwiched between the magnetic tape becomes released can thus be restrained. This movement is also restrained by the frictional force due to contact of the magnetic tape with the tape guide. As a result, uneven winding of the magnetic tape can be lessened.

Also, when the magnetic tape contacts the outer peripheral surface of the magnetic tape that has been wound around the reel, the magnetic tape presses the outer peripheral surface of the already-wound magnetic tape towards the core of the reel. Though an air layer that has formed between the wound magnetic tape is released from between the magnetic tape in this process, since the pressing force due to this contact is comparatively weak, the air is released gradually. As a result, the magnetic tape is less likely to undergo sliding movement in the width direction and uneven winding of the magnetic tape is thus restrained.

Also, with the above-described magnetic tape cartridge, the tape guide preferably has flanges that restrict the width direction of the magnetic tape. By this arrangement, since the magnetic tape is restricted in position in the width direction immediately prior to being wound around the reel, uneven winding can be restrained further. Also, since the magnetic tape is restricted in position by the tape guide after contacting the outer periphery of the reel (the wound magnetic tape) and is thus positioned in the width direction after the vibration of the magnetic tape drive are restrained, uneven winding can be minimized. Such a magnetic tape cartridge may be applied to a magnetic tape cartridge with either a single reel or a plurality of reels.

### DESCRIPTION OF THE DRAWINGS

FIG. 1 is an exploded perspective view showing the component parts of a magnetic tape cartridge of a first embodiment of this invention.

FIG. 2 is a plan view showing the magnetic tape cartridge in a condition where the upper half and the compression coil spring have been removed.

FIG. 3 is a perspective view illustrating a tape guide.

FIG. 4 is a sectional view illustrating the manner in which the tape guide is mounted.

FIG. 5 is a sectional view showing the running condition of magnetic tape inside the cartridge case.

FIG. 6A and FIG. 6B are partial sectional views showing the conditions of an air layer formed between wound magnetic tape, with FIG. 6A being a diagram showing the vicinity of the outer peripheral surface of the wound magnetic tape that contacts the magnetic tape as the magnetic tape runs towards the tape guide from the opening, and FIG. 6B being a diagram showing the vicinity of the outer peripheral surface of the magnetic tape around which the magnetic tape guided by the tape guide is wound again.

FIG. 7 is an exploded perspective view showing the component parts of a magnetic tape cartridge of a second embodiment of this invention.

FIG. 8 is a sectional view showing the running condition of magnetic tape inside the cartridge case.

FIG. 9 is a sectional view showing the running condition of magnetic tape inside the cartridge case.

FIG. 10 is a sectional view showing the running condition of magnetic tape inside the cartridge case.

### DESCRIPTION OF THE PREFERRED EMBODIMENTS

Embodiments of this invention shall now be described in detail with reference to the drawings where necessary.

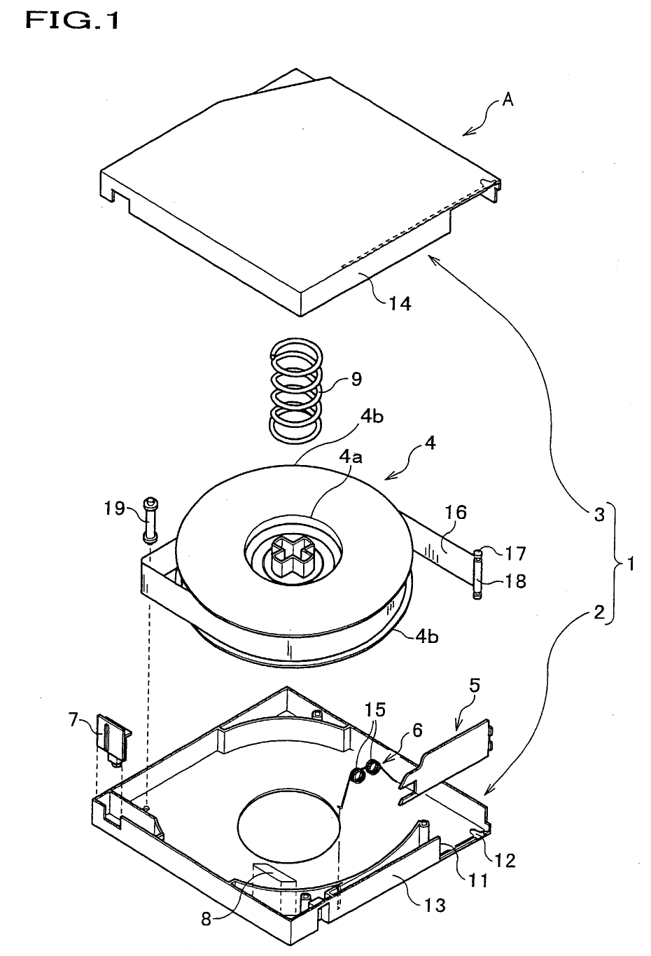

FIG. 1 is an exploded perspective view of a magnetic tape cartridge of a first embodiment of this invention. This magnetic tape cartridge A is a magnetic tape cartridge equipped with a single reel, and as shown in FIG. 1, comprises a cartridge case 1, a sliding door 5, spring member 6, a reel 4, a tape guide 19, a erroneous erasure prevention tab 7, an IC chip 8, and a compression coil spring 9.

The Cartridge case 1 comprises a lower half 2, which forms the lower half of the case, and an upper half 3, which forms the upper half of the case. A space is formed inside the cartridge case 1 by the combination of this lower half 2 and upper half 3.

Near a corner of one side wall of cartridge case 1, an opening 11, from which a magnetic tape 16 is drawn out, is formed across lower half 2 and upper half 3. A holding part 12, which is for a leader pin 17, to be described below, and is directed from opening 11 towards the inner side of the cartridge case 1, is engraved in the inner surface of the lower half 12. The Sliding door 5 is disposed along the side wall on which the opening 11 is formed. Sliding door 5 slides along side wall 13 of the lower half 2 and side wall 14 of the upper half 3 and the opening 11 can be opened and closed by this sliding movement of the sliding door 5. Also, the sliding door 5 is constantly pressed in the direction of closing the opening 11 by the spring member 6, which is a torsion coil spring having two coil parts 15.

The reel 4 is disposed inside such a cartridge case 1. This reel 4 comprises a reel core 4a and flanges 4b, disposed on both ends of the reel core 4a. This reel 4 is positioned in a manner enabling rotation about a rotation axis that is perpendicular to the bottom face of the lower half 2. Also, with the reel 4, the magnetic tape 16 is wound around the reel core 4a. At the front end of the magnetic tape 16, a leader pin 17 is clamped by a clip 18. By the leader pin 17 being held by the abovementioned holding part 12, the front end part of the magnetic tape 16 is held near the opening 11. This leader pin 17 serves as a part that engages with a tape loading mechanism of an unillustrated magnetic tape drive in order to draw out the magnetic tape 16.

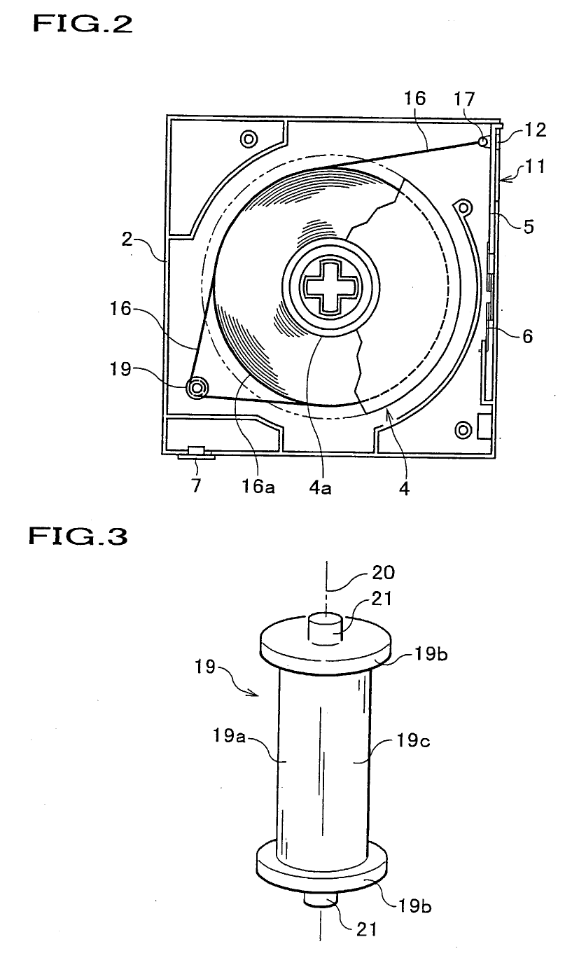

FIG. 2 is a plan view, showing the magnetic tape cartridge in a condition where the upper half 3 and the compression coil spring 9 have been removed. As shown in FIG. 2, a tape guide 19 is disposed alongside the reel 4 inside the cartridge case 1. The outermost part of the magnetic tape 16 that is wound around the reel 4 is put across this tape guide 19. The magnetic tape 16 is guided by the tape guide 19 in a manner whereby it is separated once from the outer peripheral surface 16a of the wound magnetic tape 16. The magnetic tape 16 is then guided so that, as it is directed from the tape guide 19 to the opening 11, it contacts the outer peripheral surface 16a of the wound magnetic tape 16 again.

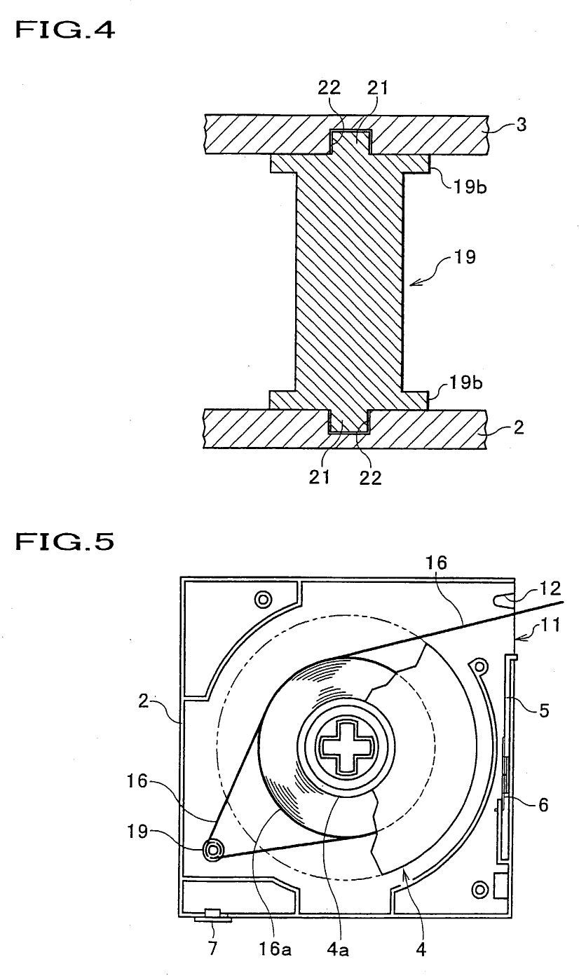

As shown in FIG. 3, the tape guide 19 comprises a cylindrical main guide body 19a and a pair of flanges 19b formed on the respective ends of the main guide body 19a. The outer peripheral surface of this main guide body 19a serves as a magnetic tape guiding surface 19c that guides the magnetic tape. At each end of the main guide body 19a, a supporting shaft 21 is formed so as to protrude along the central axis 20 of the main guide body 19a. As shown in FIG. 4, by these supporting shafts 21 being axially supported in holes 22 formed on the inner surfaces of the lower half 2 and the upper half 3, the tape guide 19 is rotatably supported with respect to the cartridge case 1.

Such a magnetic tape cartridge A is used by installing in a magnetic tape drive (not shown). When the magnetic tape cartridge A is installed in a magnetic tape drive, the sliding door 5 is pushed open by an arm (not shown) of the magnetic tape drive. A tape loading mechanism (not shown) of the magnetic tape drive engages with the leader pin 17, attached to the front end of the magnetic tape 16, and draws out the magnetic tape 16 from the magnet tape cartridge A. The front end of the magnetic tape 16 that has been drawn out is fixed to a reel core inside the magnetic tape drive, and as the magnetic tape 16 is wound around this reel core, data are recorded or reproduced by a magnetic head inside the magnetic tape drive.

With the magnetic tape cartridge A, which is used in the above-described manner, after the recording or reproduction of data is completed, the magnetic tape 16 is wound up by the reel 4. The magnetic tape 16 that was wound around the reel core inside the magnetic tape drive is introduced via the opening 11 into the cartridge case 1 and wound again around the rotating reel core 4a. As the magnetic tape 16 runs towards tape guide 19 in this process, it contacts the outer peripheral surface 16a of the wound magnetic tape 16 as shown in FIG. 5.

By contacting of the magnetic tape 16 with the outer peripheral surface 16a, the vibration in the tape width direction, which is transmitted from the magnetic tape drive, is restrained. Since the speed of the outer peripheral surface 16a and the speed of the magnetic tape 16 are always equal, friction will not occur between the two. The tape guide 19 changes the running direction of the magnetic tape 16 while rotating in accordance to the running of the magnetic tape 16 and, at the same time, the position in the width direction of the magnetic tape 16 is restricted by the flanges 19b. Vibration in the width direction of the magnetic tape 16 is thus restricted to the minimum in the process of guiding the magnetic tape 16 in this manner. As a result, the position of the magnetic tape 16 in the width direction is extremely stable when the magnetic tape 16 overlaps onto the abovementioned outer peripheral surface 16a again from the tape guide 19. The magnetic tape 16 will therefore be wound around the reel core 4a without giving rise to uneven winding.

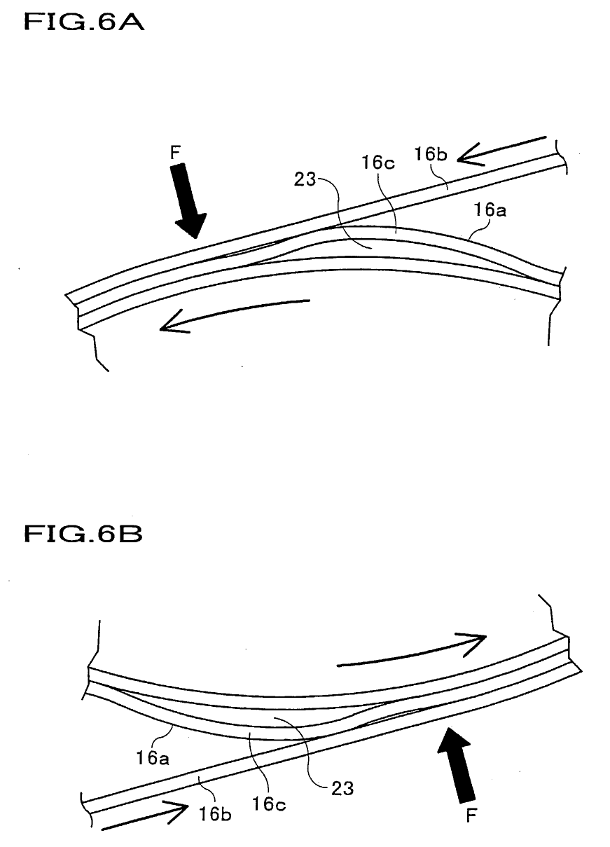

FIGS. 6A and 6B show partial sectional views of the conditions of an air layer 23 formed between the wound magnetic tape 16. FIG. 6A is a diagram showing the vicinity of the outer peripheral surface 16a of the wound magnetic tape 16 that contacts the magnetic tape 16 as the magnetic tape 16 runs towards the tape guide 19 from the opening 11, and FIG. 6B is a diagram showing the vicinity of the outer peripheral surface 16a of the magnetic tape 16 around which the magnetic tape 16 guided by the tape guide 19 is wound again. As shown in FIG. 6A, with the magnetic tape cartridge A of the present embodiment, the magnetic tape 16b that is introduced from the opening 11 contacts the outer peripheral surface 16a of the magnetic tape 16 that is wound around the reel 4. By its tension, the introduced the magnetic tape 16b presses the base magnetic tape 16c, which receives the magnetic tape 16b, towards the reel core 4a. At the same time, the air of air layer 23, which is caught by the base magnetic tape 16c at the reel core 4a side, is pressed by the introduced magnetic tape 16b. Air is gradually released from the air layer 23 by such a pressing force F. The air layer 23 between the magnetic tape will therefore not lift the magnetic tape 16c to move it in the width direction.

Also as shown in FIG. 6B, the magnetic tape 16b is guided again towards the outer peripheral surface 16a of the magnetic tape 16 by the tape guide 19 and overlaps with the outer peripheral surface 16a of the wound magnetic tape 16. By its tension, the magnetic tape 16 that is thus guided by the tape guide 19 presses the base magnetic tape 16c, which receives the magnetic tape 16b, towards the reel core 4a. Air is released from the air layer 23 by this pressing force F. Though the magnetic tape 16c adjacent to air layer 23 tends to move in the tape width direction in this process, since movement is impeded by the friction with the abovementioned contacting magnetic tape 16b, uneven winding of the magnetic tape 16 is restricted to the minimum.

Thus with the magnetic tape cartridge A of the present embodiment, the air layer 23 is pressed at two locations of the outer peripheral surface 16a and eliminated gradually from between the wound magnetic tape 16. Uneven winding of the magnetic tape 16 due to the forming of air layer 23 is thus prevented further.

With the magnetic tape 16, which is wound without giving rise to uneven winding as described above, the vibration in the tape width direction is kept low when the tape is drawn out from the magnetic tape cartridge A subsequently. Thus magnetic tape 16 will be accurately positioned with respect to a magnetic head and the recording and reproduction data will be carried out accurately. Also with this magnetic tape cartridge A, due to the prevention of uneven winding, damaging of the magnetic tape 16, such as the bending of the tape edge, can be avoided.

A second embodiment of this invention shall now be described.

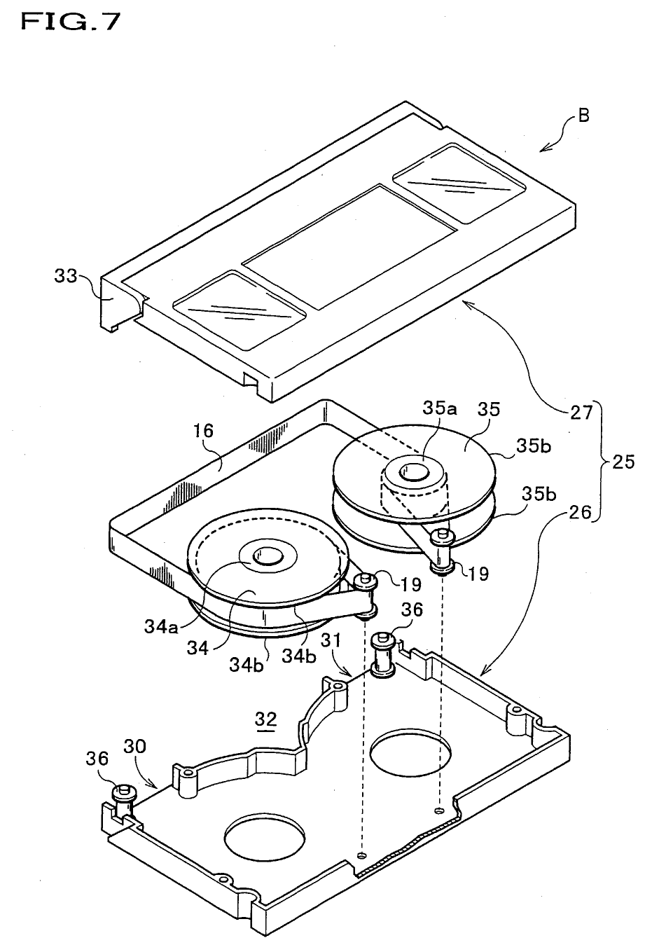

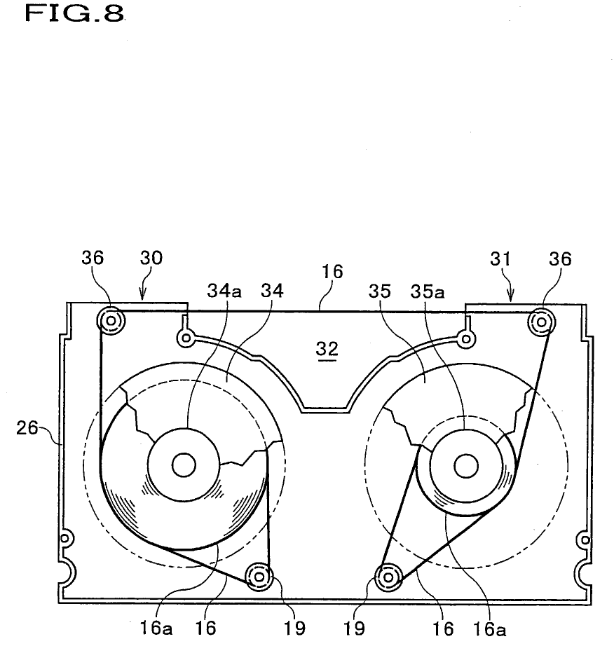

FIG. 7 is an exploded perspective view showing the structure of a magnetic tape cartridge according to a second embodiment of this invention. With this second embodiment, the same arrangements as those of the above-described first embodiment shall be provided with the same numerals and redundant descriptions shall be omitted. This magnetic tape cartridge B is a magnetic tape cartridge having two reels, and as shown in FIG. 7, comprises a cartridge case 25, reels 34 and 35, and tape guides 19.

The cartridge case 25 comprises a lower half 26, which forms the lower half of the case, and an upper half 27, which forms the upper half of the case. A space is formed inside the cartridge case 25 by the combination of this lower half 26 and upper half 27.

A first opening 30 and a second opening 31 are formed near the respective ends of one side face of the lower half 26. Between the first opening 30 and the second opening 31, a receiving space 32, which receives a tape drawing member (not shown) of a magnetic drive (not shown) when this magnetic tape cartridge is installed in the magnetic tape drive. The upper half 27 is provided with a lid 33, which covers this receiving space 32 and protects a magnetic tape 16 that is spanned across the receiving space 32 as described below.

In the interior of such a cartridge case 25, a first reel 34 and a second reel 35 are disposed in an aligned manner. First reel 34 comprises a reel core 34a and flanges 34b provided on the respective ends of reel core 34a. Second reel 35 comprises a reel core 35a and flanges 35b provided on the respective ends of the reel core 35a. Each of the reels 34 and 35 is disposed in a manner enabling rotation about a rotation axis that is perpendicular to the bottom face of the lower half 26.

A single roll of magnetic tape 16 is spanned across the first and second reels 34 and 35 and the magnetic tape 16 has one end attached to the reel core 34a of first reel 34, and the other end attached to the reel core 35a of second reel 35. The magnetic tape 16 is wound around the respective reel cores 34a and 35a of the first and second reels 34 and 35. As shown in FIG. 8, this magnetic tape 16 is lead from the first reel 34 to the second reel 35 via the first opening 30 and the second opening 31 and is spanned across the abovementioned receiving space 32.

As shown in FIG. 8, inside the cartridge case 25, tape guides 19 are positioned alongside the first and second reels 34 and 35 and respectively according to each of reels 34 and 35. Each of the tape guides 19 has the magnetic tape 16 of the corresponding reel 34 or 35 put across it. Magnetic tape 16 is guided by each of the tape guides 19 so as to be separated once from the outer peripheral surface 16a of the wound magnetic tape 16. Furthermore, after being guided by each of the tape guides 19, the magnetic tape 16 is guided so as to contact the outer peripheral surface 16a of the wound magnetic tape 16 again in the process of being directed from the tape guide 19 to the first and second openings 30 and 31.

Auxiliary tape guides 36 are disposed at the first and second openings 30 and 31, respectively. By these auxiliary tape guides 36, the magnetic tape 16 is guided so as to be spanned across the abovementioned receiving space 32.

As with the first embodiment, with such a magnetic tape cartridge B, by the restriction of the position of magnetic tape 16 in the width direction by the tape guides 19 and the contact of magnetic tape 16 with the outer peripheral surfaces 16a of the magnetic tape 16 wound around the first and second reels 34 and 35, the vibration in the tape width direction, which is transmitted from a magnetic tape drive, is restrained (see FIG. 5). Also as with the first embodiment, by the magnetic tape 16 contacting the outer peripheral surfaces 16a of the magnetic tape 16 wound around the first and second reels 34 and 35, the air layer 23 formed between the magnetic tape is removed without causing width-direction movement of the magnetic tape 16c overlapped over the air layer 23 (see FIG. 6). As a result, uneven winding of the magnetic tape is prevented, and as with the first embodiment, recording and reproduction of data by a magnetic head are carried out more accurately. Also with this magnetic tape cartridge B, since uneven winding is prevented, damaging of the magnetic tape, such as bending of the tape edge, can be avoided.

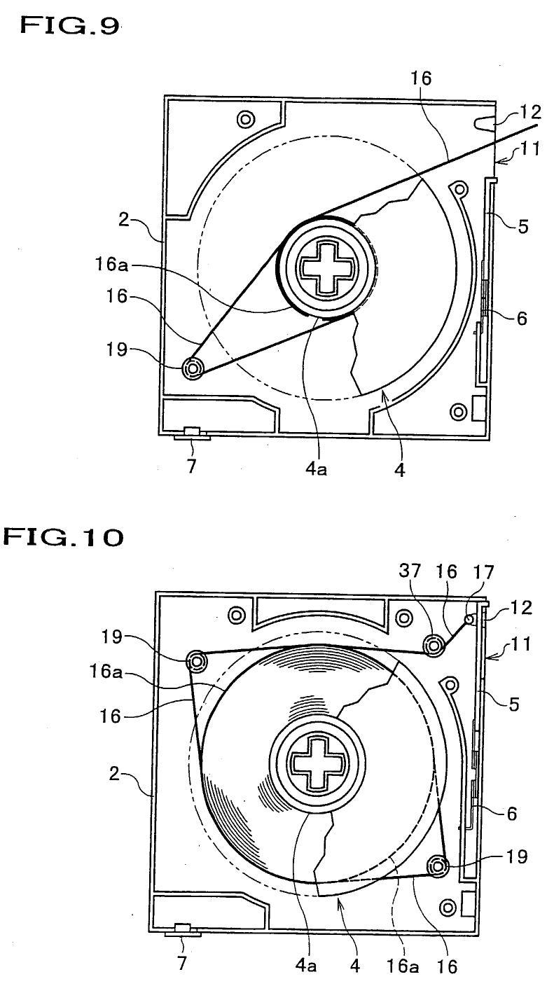

With the magnetic tape cartridge described in detail above according to the present invention, it is desirable, for example when the magnetic tape 16 is conveyed to a magnetic head (not shown) of a magnetic tape drive as shown in FIG. 9, for the magnetic tape 16 to be positioned so as to contact the outer peripheral surface 16a even after most of the wound magnetic tape 16 has been conveyed to the magnetic tape drive side. By positioning the magnetic tape 16 thus, the vibration of magnetic tape 16 in the width direction will be restrained constantly. If the vibration of magnetic tape 16 is restrained constantly, accurate recording and reproduction of data will be carried out over the entirety of magnetic tape 16, from its front end to its rear end. In order to position the magnetic tape 16 in this manner, for example, the outer diameters of reel cores 4a, 34a and 35a and the outer diameter of main guide body 19a, which defines the tape contacting surface 19c, are adjusted. The tape guide 19, used in this magnetic tape cartridge of the present invention is not limited to that illustrated with the embodiments, and the shape thereof is not limited in particular as long as it can guide the magnetic tape 16 accurately in a prescribed direction. For example, the tape guide 19 does not have to be rotatable with respect to the cartridge case 1 or 25 and may, for example, be a cylindrical pin that is formed integral to cartridge case 1 or 25. Also, the cross-sectional shape of tape guide 19 is not limited to a circular shape and may, for example, be semi-circular shape as long as the magnetic tape 16 can be guided smoothly. Flanges 19b of the tape guide 19 are also not required necessarily.

Also with the magnetic tape cartridge of the present invention, the number of tape guides 19 is not limited in particular, and for example as shown in FIG. 10, two or more tape guides 19 may be positioned for a single reel 4. In positioning two or more tape guides 19, the magnetic tape cartridge may have an auxiliary tape guide 37 positioned to guide the magnetic tape 16 so that it contacts accurately with the outer peripheral surface 16a of the wound magnetic tape 16.

What is claimed is:

1. A magnetic tape cartridge comprising: a cartridge case; a reel, housed inside said cartridge case and around which a magnetic tape is wound; and a tape guide, disposed alongside said reel, guiding said magnetic tape so as to separate it once from the magnetic tape wound around the reel, and guiding said separated magnetic tape so that said magnetic tape contacts again the outer peripheral surface of said wound magnetic tape.

2. The magnetic tape cartridge as set forth in claim 1, wherein the number of said reel is one.

3. The magnetic tape cartridge as set forth in claim 1, wherein the number of said reel is two and said tape guide is disposed, respectively for each reel.

4. The magnetic tape cartridge as set forth in claim 2, wherein a plurality of said tape guides are provided.

5. The magnetic tape cartridge as set forth in claim 3, wherein a plurality of said tape guides are disposed, respectively, for each of said reel.

6. The magnetic tape cartridge as set forth in claim 2, wherein
said tape guide has flanges provided at both ends of a main guide body.

7. The magnetic tape cartridge as set forth in claim 3, wherein
each of said tape guides has flanges provided at both ends of a main guide body.

8. The magnetic tape cartridge as set forth in claim 4, wherein
each of said tape guides has flanges provided at both ends of a main guide body.

9. The magnetic tape cartridge as set forth in claim 5, wherein
each of said tape guides has flanges provided at both ends of a main guide body.

10. The magnetic tape cartridge as set forth in claim 2, wherein
said tape guide is rotatable with respect to said cartridge case.

11. The magnetic tape cartridge as set forth in claim 3, wherein
each of said tape guides is rotatable with respect to said cartridge case.

12. The magnetic tape cartridge as set forth in claim 4, wherein
each of said tape guides is rotatable with respect to said cartridge case.

13. The magnetic tape cartridge as set forth in claim 5, wherein
each of said tape guides is rotatable with respect to said cartridge case.

14. The magnetic tape cartridge as set forth in claim 2, wherein
the core of said reel has flanges provided at both ends.

15. The magnetic tape cartridge as set forth in claim 3, wherein
the core of each of said reels has flanges provided at both ends.

16. The magnetic tape cartridge as set forth in claim 4, wherein
the core of said reel has flanges provided at both ends.

17. The magnetic tape cartridge as set forth in claim 5, wherein
the core of each of said reels has flanges provided at both ends.

18. A tape winding method of winding a magnetic tape around a reel comprising:
a tape contacting step of putting said magnetic tape, immediately prior to being wound around said reel, in contact with the outer peripheral surface of said magnetic tape wound around said reel;
a tape separating step of separating said magnetic tape put in contact with said reel away from said reel; and
a tape winding step of winding said magnetic tape, which has been separated from said reel, around the reel.
